(19) United States
(12) Patent Application Publication
(10) Pub. No.: US 2018/0002232 A1
(43) Pub. Date: Jan. 4, 2018

(54) A HYDRAULIC COMPOSITION FOR THE CONSTRUCTION OF PAVEMENTS

(71) Applicant: LAFARGE, Paris (FR)

(72) Inventors: Antoine CREYX, SAINT QUENTIN FALLAVIER (FR); Arnaud JONNEKIN, OLOUISE (FR); Benoit MATHONIER, SAINT QUENTIN FALLAVIER (FR); Samir MESSAD, LYON (FR)

(21) Appl. No.: 15/537,798

(22) PCT Filed: Dec. 18, 2015
(86) PCT No.: PCT/FR2015/053619

§ 371 Date: Jun. 19, 2017

(30) Foreign Application Priority Data
Dec. 18, 2014 (FR) 1462816

(51) Int. Cl. C04B 28/04; C04B 40/06; C04B 111/00

(52) U.S. Cl. CPC C04B 28/04; C04B 40/0625; C04B 2111/0075; C04B 2111/00068

(57) ABSTRACT

A hydraulic composition for the construction of pavements, and in particular for the repair of pavements, includes a hydraulic binder including a cement, 0.18% to 0.35% of a superplasticiser, where the percentage is expressed by dry weight compared to the cement, and where the superplasticiser includes a branched polymer including at least one pendant chain, with a terminal function of the phosphonate or phosphate type, and 0.25% to 2% of a setting accelerator, where the percentage is expressed by dry weight compared to the cement, where the setting accelerator includes a calcium salt, where the hydraulic composition has a Water/Cement ratio higher than 0.38 and strictly less than 0.45.

The present invention relates to the field of the construction of pavements.

More specifically, the object of the present invention is a hydraulic composition for the construction of pavements, in particular for the repair of pavements.

The term “repair” is understood to mean the conduct of public works consisting in removing all or part of the wearing course of a pavement in order to replace it by a new wearing course.

It is known to construct pavements made from asphalt mix, for example made from gravel bitumen.

Asphalt mix has the advantage that it rapidly acquires compression resistances after compacting.

Asphalt mix is thus often used to repair a pavement.

However, under certain creep or shearing stresses asphalt mix may be subject to degradation mechanisms, in particular rutting of the pavement's wearing courses.

These stresses are caused by the pressing and friction of the wheels on the pavement, in particular during the braking, acceleration and bend-taking phases.

Rutting is particularly significant in pavements of giratory interchanges where the trajectory is curved and where the braking and acceleration phases are more substantial.

Furthermore, rutting on pavements made from asphalt mix is particularly pronounced when temperatures are high, since the viscosity of asphalt mixs tends to reduce as the temperature increases.

Thus, use of asphalt mix allows rapid repair of a pavement, but can require a relatively high maintenance frequency compared to the use of other materials, in particular concrete.

It is known to construct concrete pavements, in particular the pavements of giratory interchanges, to overcome the problem of rutting associated with use of asphalt mix.

Fresh concrete is brought from the concrete batching plant to the site using mixer lorries.

The fresh concrete can then be poured on to the ground in formwork and then spread and compacted using a vibratory screed.

According to one variant, the fresh concrete can be poured into the hopper of a slipform machine or the hopper of a paver.

Finishing of the wearing course is accomplished, for example by sweeping, in order to create a surface condition with skid resistance compatible with vehicle traffic on the pavement.

According to the professional recommendations cited in the work “Concrete pavements—Technical guide, 2000, LCPC/SETRA”, a pavement can be reopened to traffic when its compression resistance is at least 20 MPa, determined using the test method described in standard NF EN 12390-3 of April 2012.

Currently used concretes attain a compression resistance of at least 20 MPa after several days.

Consequently, currently used concretes mean that the pavement may be unavailable for up to several days, compared to one day in the case of asphalt mix.

It is known to use fast-setting concretes for the construction of buildings.

These fast-setting concretes or mortars use fast-setting and fast-hardening hydraulic binders. Concretes using such binders in their compositions, when applied, rapidly acquire high mechanical resistances.

These concretes are fluid or self-placing concretes (or self-compacting concretes) and have workability of one hour minimum to two hours maximum.

They preferably have a compression resistance of at least 1 MPa 4 hours after mixing in the case of fluid concretes, and at least 1 MPa 5 hours after mixing in the case of self-placing (or self-compacting) concretes, and at least 12 MPa 24 hours after mixing.

The workability of fluid concretes is measured by the slump height using an Abrams cone, according to the test method described in standard NF EN 12350-2 of April 2012.

This test method enables concretes to be categorised into several slump categories ranging from S1 to S5 according to the slump value.

It is considered that a concrete is fluid when the slump value is at least 150 mm, preferably at least 180 mm, corresponding to slump category S4.

The workability of self-placing (or self-compacting) concretes is generally measured from the slump flow, according to the test method described in standard NF EN 12350-8 of November 2010.

This test method enables concretes to be categorised into several flow categories ranging from F1 to F6 according to the slump flow value.

It is considered that a concrete is self-placing (or self-compacting) when the value of this flow is greater than 620 mm (and generally less than 800 mm), corresponding to flow category F6.

The consistency of these fluid or self-placing (or self-compacting) concretes means that they cannot be used on a pavement.

In particular, such fluid or self-placing (or self-compacting) concretes are incompatible with the use of a slipform machine or a paver.

In addition, these fluid or self-placing (or self-compacting) concretes cannot be given a gradient.

The goal sought according to the present invention thus consists in formulating a ready-mixed hydraulic composition with a non-fluid consistency in slump categories S1, S2 or S3, making it usable on the site, maintained for at least the first 90 minutes, and enabling a compression resistance of at least 20 MPa to be attained 24 hours after mixing at 20° C., preferably 18 hours after mixing at 20° C. or even 14 hours after mixing at 20° C., a resistance of at least 20 MPa 24 hours after mixing at 10° C., and a resistance of at least 20 MPa 12 hours after mixing at 30° C.

The term “ready-mixed” is understood to mean a hydraulic composition delivered in the fresh condition which requires no modification of its composition on site.

In particular, the additives are incorporated when the hydraulic composition is produced in the concrete batching plant, not on site.

Production of such a hydraulic composition is made particularly difficult since the aim is to produce an accelerated hydraulic composition and therefore one with limited workability.

To this end, the present invention relates to a hydraulic composition for construction of pavements, and in particular for the repair of pavements, comprising:
a hydraulic binder comprising a cement,
0.18% to 0.35% of a superplasticiser, where the percentage is expressed by dry weight compared to the cement, and where said superplasticiser comprises a branched polymer comprising at least one pendant chain, with a terminal function of the phosphonate or phosphate type, and
0.25% to 2% of a setting accelerator, where the percentage is expressed by dry weight compared to the cement, where said setting accelerator comprises a calcium salt,

and where said hydraulic composition has a Water/Cement mass ratio greater than or equal to 0.38 and strictly less than 0.45.

Such a hydraulic composition enables the problem of rutting associated with the use of asphalt mix to be overcome.

Indeed, concrete is not subject to a degradation mechanism such as rutting.

In addition, concrete pavements have several other advantages over pavements made of asphalt mix, in particular in terms of rutting resistance, durability and maintenance costs.

A hydraulic composition generally comprises a hydraulic binder and water, possibly granulates and possibly additives, for example other than those described above. Hydraulic compositions include compositions both in the fresh state and in the hardened state, for example a cement slurry, a mortar or a concrete.

The granulates used in the compositions according to the invention include sand(s) and chip(s) defined according to standard NF EN 12620-A1 of June 2008.

The expression “hydraulic binder” is understood to mean, in the present invention, any compound which has the property that it undergoes hydration in the presence of water, and the hydration of which enables a solid with mechanical characteristics to be obtained. The hydraulic binder may be a cement according to “cement” standard NF EN 197-1 of April 2012.

A cement generally comprises a clinker and calcium sulphate. The clinker may, in particular, be a Portland clinker.

A Portland clinker is obtained by high-temperature clinkering of a blend comprising limestone and, for example, clay. For example, a Portland clinker is a clinker as defined in standard NF EN 197-1 of April 2012.

A Portland clinker is generally co-ground with calcium sulphate to produce a cement. The calcium sulphate used comprises gypsum (dihydrated calcium sulphate, CaSO₄.2H₂O), semi-hydrate (CaSO₄.1/2H₂O), anhydrite (anhydrous calcium sulphate, CaSO₄) or one of their blends. Gypsum and anhydrite exist in the natural state. It is also possible to use a calcium sulphate which is a by-product of certain industrial processes.

The cement is, for example, a Portland cement of the CEM I type according to “Cement” standard NF EN 197-1 of April 2012, preferably in resistance category 42.5 N, 42.5 R, 52.5 N or 52.5 R according to this same standard.

The cement can also be a cement of the CEM II, CEM III, CEM IV or CEM V type according to this same standard.

The cement can also include at least one mineral addition.

The mineral additions are, for example, slags (for example, as defined in standard NF EN 197-1 of April 2012, paragraph 5.2.2), natural or artificial pozzolans (for example as defined in standard NF EN 197-1 of April 2012, paragraph 5.2.3), fly ashes (for example as defined in standard NF EN 197-1 of April 2012, paragraph 5.2.4), calcinated schists (for example as defined in standard NF EN 197-1 of April 2012, paragraph 5.2.5), calcium carbonate-based mineral additions, for example limestone (for example as defined in standard NF EN 197-1 of April 2012, paragraph 5.2.6), silica fumes (for example as defined in standard NF EN 197-1 of April 2012, paragraph 5.2.7), metakaolins or their blends.

The invention thus concerns a hydraulic composition comprising a hydraulic binder comprising a cement, a specific superplasticiser the proportion of which is defined in a determined dry weight range relative to the cement, an setting setting accelerator comprising a calcium salt the proportion of which is defined in a range determined by dry weight compared to the cement, and with a water/cement ratio also defined in a determined range.

The combination of the various components of the hydraulic composition in the various claimed ranges, together with a determined Water/Cement ratio, enable the obtained hydraulic composition to be given a non-fluid consistency in slump categories S1, S2 or S3, making it suitable for use on site, and maintained for at least the first 90 minutes, and with a compression resistance which may attain at least 20 MPa 24 hours after mixing at 20° C., preferably 18 hours after mixing at 20° C. or even 14 hours after mixing at 20° C., a resistance of at least 20 MPa 24 hours after mixing at 10° C., and a resistance of at least 20 MPa 12 hours after mixing at 30° C.

Consequently, the use of such a hydraulic composition enables the unavailability time of the pavement to be reduced substantially compared to the current concrete solutions.

In addition, this unavailability time of the pavement is close to the unavailability time resulting from the solution using asphalt mixs.

A consistency in slump category S1 enables the hydraulic composition to be applied to the pavement by a slipform machine or a paver.

A consistency in slump category S2 or S3 enables the hydraulic composition to be applied to the pavement using a vibratory screed.

These various application devices enable a satisfactory surface evenness to be obtained, but also enable the concrete pavement to be given a gradient, which is not possible with a fluid concrete.

Such consistencies and such workability are obtained, in particular, through use of a specific additive, in particular a superplasticiser.

This superplasticiser is present in the hydraulic composition in quantities which may vary from 0.18% to 0.35% by dry weight compared to the cement.

The expression “superplasticiser” is understood to mean an additive which is a high-range water reducer which, with constant consistency, enables the quantity of water required for production of a concrete to be reduced by over 12%. A superplasticiser has a fluidifying action in the sense that, for a given quantity of water, the workability of the concrete is increased in the presence of the superplasticiser.

The superplasticiser used in the hydraulic composition according to the invention comprises a branched polymer comprising at least one pendant chain having a terminal function of the phosphonate or phosphate type.

This terminal function of the phosphonate or phosphate type of the at least one pendant chain of the superplasticiser enables this pendant chain to attach to cement grains.

More specifically, the superplasticiser comprises at least one organic compound (I) which is a hydrosoluble or hydrodispersible organic compound (I), having at least one amino-di(alkylenephosphonic) group and at least one polyoxyalkylated chain, or at least one salt of compound (I), where said compound (I) has the following formula:

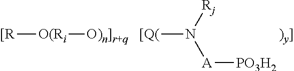

where:
R is a hydrogen atom or a monovalent hydrocarbonate group, saturated or not, containing 1 to 18 (inclusive) carbon atoms and possibly one or more heteroatoms: R is preferably a hydrogen atom or a monovalent hydrocarbonate group, saturated or not, containing 1 to 4 carbon atoms;
50% to 100% of the Ri are ethylene, 0 to 50% of the Ri are propylene and 0 to 5% of any other Ri are similar or different to one another, and represent an alkylene such as butylene, amylene, octylene or cyclohexene, or an arylene such as styrene or methylstyrene; these Ri may contain one or more heteroatoms;
Q is a hydrocarbonate group containing 2 to 18 (inclusive) carbon atoms and possibly one or more heteroatoms; Q is preferably a hydrocarbonate group containing 2 to 12 (inclusive) carbon atoms, more preferentially 2 to 6 (inclusive) carbon atoms, even more preferentially represents ethylene or propylene;
A is an alkylidene group containing 1 to 3 (inclusive) carbon atoms: A preferentially represents the methylene group;
the Rj are similar or different to one another and can be chosen from among:
   the A-P03H2 group, where A has the above-mentioned meaning,
   and the group:

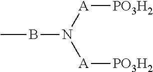

where B refers to an alkylene group containing 2 to 8 (inclusive) carbon atoms: B preferably represents ethylene or propylene and A has the above-mentioned meaning;
“n” is an integer between 20 to 250, inclusive;
“r” is the number of groups (R—O(Ri-O)n] carried by all the Rj;
“q” is the number of groups [R—O(Ri-O)n] carried by Q;
the sum “r+q” is equal to 3 at most;
“y” is an integer equal to 1 or 2.

Preferably, the superplasticiser used according to the present invention does not include carboxylic vinylic monomers, as illustrated by the examples below do not enable a satisfactory consistency of the hydraulic composition to be obtained.

According to one aspect of the invention the number of pendant chains is less than or equal to three.

The hydraulic composition also comprises a setting accelerator comprising a calcium salt.

According to one aspect of the invention, the calcium salt comprises a calcium nitrite, a calcium nitrate or their blends.

The calcium salt is present in the hydraulic composition in quantities which may vary from 0.26% to 2% by dry weight compared to the cement.

The hydraulic composition may also include other additives for hydraulic composition, in particular an air-entraining agent, a viscosity control agent, a retardant or an agent for inerting clays, for example one of those described in standards NF EN 934-2 of August 2012, NF EN 934-3 of October 2012 or NF EN 934-4 of August 2009.

Agents for inerting clays are compounds which enable the detrimental effects of clays on the properties of hydraulic binders to be reduced or prevented. Agents for inerting clays include those described in WO 2006/032785 and WO 2006/032786

In addition, those skilled in the art are able to select the various values of each component in each claimed range according to the characteristics sought in the hydraulic composition and the climatic conditions.

Thus, the higher the proportion of superplasticiser within the claimed range, the greater the slump, and therefore the more the hydraulic composition tends towards a slump category S3.

Similarly, the higher the proportion of setting accelerator within the claimed range, the earlier the hydration of the hydraulic composition occurs, enabling compression resistances to be obtained more rapidly.

Of course, rapid acquisition of compression resistances is achieved to the detriment of workability.

Similarly, an increase of the Water/Cement ratio will tend to retard the acquisition of these resistances, but improve workability.

It is also known that increasing temperature accelerates the process of hydration of a hydraulic composition and therefore reduces its workability.

An increase of temperature when producing the hydraulic composition may thus be compensated by an increase of the proportion of superplasticiser and a reduction of the proportion of setting accelerator.

Conversely, a reduction of temperature when producing the hydraulic composition may be compensated by a reduction of the proportion of superplasticiser and an increase of the proportion of setting accelerator.

Furthermore, concretes for pavements must also satisfy particular requirements, in particular depending on their environmental exposure, as stipulated in standard NF EN 206-1 of December 2012.

In particular, a pavement subject to freezing/unfreezing cycles must include a minimum of 4% of entrapped air.

Thus, according to one aspect of the invention, the hydraulic composition comprises 0.001% to 0.1% of an air-entraining agent, which percentage is expressed by dry weight relative to the cement, and preferably 0.001% to 0.06%.

The presence of an air-entraining agent in the stated proportions enables a minimum of 4% of entrapped air to be incorporated in the hydraulic composition, depending on the region in which the concrete must be poured, in order to satisfy the requirement of standard NF EN 206-1 of December 2012.

Having to obtain high resistances in the short term is, in principle, in contradiction with the standard-based requirement to incorporate a minimum of 4% of entrapped air in order to be able to resist the freezing/unfreezing cycles.

The present invention enables the compromise between quantity of entrapped air imposed by standard NF EN 206-1 of December 2012 and the compression resistance of the hydraulic composition to be managed.

The presence of an air-entraining agent also enables the hydraulic composition to be given satisfactory resistance to the scaling due to freezing temperatures when de-icing salts are present.

Air-entraining agents are additives which entrain and stabilise a high number of air microbubbles, distributed uniformly in the mass of the hydraulic composition, which subsist after the hydraulic composition has hardened.

Unlike entrapped air bubbles, intentionally entrained air bubbles are extremely small (10 to 500 μm).

These bubbles are not closely connected, and are uniformly distributed in the paste, where the paste is defined as the blend of hydraulic binder, water and air.

According to one aspect of the invention the air-entraining agent comprises a sulphonic fatty acid, a carboxylic fatty acid, or their blends.

A carboxylic fatty acid entrains air more rapidly than a sulphonic fatty acid.

However, the quantity of air entrained by a carboxylic fatty acid saturates above a certain quantity of entrained air.

A sulphonic fatty acid is more soluble than a carboxylic fatty acid, which ultimately means that it is able to entrain a higher quantity of air than that which can be entrained by a carboxylic fatty acid.

A pavement can also be categorised according to the vehicle traffic to which it is subject.

This categorisation is defined in standard “cement concrete pavements” NF P98-170 of April 2006, and is based on an estimate of the number of HGVs traversing it each day, and in each direction on the pavement.

According to the pavement's traffic category, crushed chips will preferably be used, in order to increase the adherence between the tyres of the vehicles and the pavement, rather than rolled chips.

In both cases a surface treatment to increase the adherence between the tyres of the vehicles and the pavement may be envisaged, for example by grooving, sweeping or shot blasting.

Examples, illustrating the invention without limiting its protective scope, will be described below.

Although the invention has been described in connection with particular implementation examples, it is of course the case that it is not limited to these in any sense, and that it comprises all technical equivalents of the means described, and their combinations.

### EXAMPLES

In the following various examples the percentages are expressed as mass percentages.

The term “D/d”, as defined in standard NF EN 12620+A1, is stipulated in the various tables for the sands and chips used.

### Example 1

### Selection of Superplasticiser and Definition of the Components of the Hydraulic Composition

Consistency tests on a hydraulic composition were undertaken at 20° C. with five different superplasticisers, namely:
superplasticiser 1, sold under the name Optima 203, comprising polymers from the chemical family of polyalkoxylated polycarboxylates (PCP),
superplasticiser 2, sold under the name Advaflow 450, comprising polymers from the chemical family of PCPs,
superplasticiser 3, sold under the trademark Omega 135, comprising for the most part polymers from the chemical family of PCPs,
superplasticiser 4, sold under the trademark Optima 100, belonging to the chemical family of phosphonates. This superplasticiser is a branched polymer comprising at least one pendant chain having a terminal function of the phosphonate or phosphate type.

The hydraulic composition used to test each of these four superplasticisers included cements from the Le Teil cement works, a mineral addition with a limestone filler of surface specific area 0.8 m² per gram, from the Saint Beat quarry, granulates from the La Patte and Brefauchet quarries, and one of the four superplasticisers subject to testing.

The quantity of components used for each of the four tested hydraulic compositions is summarised in table 1 below; unless otherwise specified the values are expressed in kilograms per cubic metre of hydraulic composition:

TABLE 1
Formulations of the different tested hydraulic compositions

| | | Hydraulic composition | | | |
|---|---|---|---|---|---|
| | | C1 | C2 | C3 | C4 |
| Cement | Le Teil CEM I | 416.7 | 416.7 | 416.7 | 416.7 |
| | 52.5 R | | | | |
| Filler | Saint Béat | 52.91 | 52.91 | 52.91 | 52.91 |
| Sand | 0/4 La Patte | 766.9 | 766.9 | 766.9 | 766.9 |
| Chips | 4/6 La Patte | 187.1 | 187.1 | 187.1 | 187.1 |
| | 6/10 La Patte | 187.8 | 187.8 | 187.8 | 187.8 |
| | 11/22 Brefauchet | 661.6 | 661.6 | 661.6 | 661.6 |
| Super- | superplasticiser 1 | 4.68 | | | |
| plasticisers | superplasticiser 2 | | 5.03 | | |
| | superplasticiser 3 | | | 4.38 | |
| | superplasticiser 4 | | | | 3.24 |

| | | | | |
|---|---|---|---|---|
| Effective water | 175 | 175 | 175 | 175 |
| W/C ratio | 0.42 | 0.42 | 0.42 | 0.42 |
| Volume of paste (L/m3) | 328 | 328 | 328 | 328 |
| Superplasticiser (% dry/L) | 0.22% | 0.30% | 0.22% | 0.21% |

The percentage given on the last line of table 1 indicates the proportion by dry weight of superplasticiser used in the hydraulic composition.

These tests were undertaken using the following procedure;
introduction of sand and chips into the mixer,
start-up of the mixer,
introduction within 30 seconds of pre-wetting water, equivalent to 5% of the mass of granulate; this quantity of water was then subtracted from the quantity of mixing water,
mixing for 30 seconds,
rest for 4 minutes,
with the mixer stopped, introduction of cement and if applicable filler within 1 minute,
mixing for 1 minute,
introduction within 30 seconds of the mixing water comprising the additive, whilst continuing to mix,
mixing for 2 minutes, and
stoppage of the mixer.

The mixer used is of Pemat brand, model ZK500HE. It comprises an eccentric moving blade which rotates at 60 rpm in a tank which itself also rotates in the same direction at 40 rpm. The differential speed between the eccentric moving blade and the tank creates the shearing. The shearing is amplified by a stationary blade attached to the edge of the tank, and directs the product on to the eccentric moving blade.

The slump measurements were then made according to standard NF EN 12350-02 of April 2012. The press used is of brand 3R and model Quantris.

The results of these tests are shown in table 2 below, where the values are expressed in cm:

TABLE 2
Results of slump tests with several superplasticisers

Hydraulic composition

| | | C1 | C2 | C3 | C4 |
|---|---|---|---|---|---|
| Slump (cm) | after 5 min. | 23 | 14 | 22.5 | 12 |
| | after 30 min. | 13 | 9.5 | 20 | 11 |
| | after 60 min. | | 7 | 9.5 | 10 |
| | after 90 min. | 3 | 4 | 7 | 8 |
| | after 120 | | | 7 | 8 |
| | min. | | | | |

These results enabled it to be ascertained that hydraulic compositions C1, C2 or C3 have a poor rheology maintenance. This poor rheology maintenance did not enable a consistency compatible with use on a pavement to be guaranteed.

Only hydraulic composition C4, which uses superplasticiser 4 sold by the company Chryso under the trade name Chryso® Fluid Optima 100, had a slump value after 90 min. and even after 120 min. which was very close to the initial consistency after 5 min., which gave the hydraulic composition a consistency compatible with the consistency goals sought for use on a pavement.

This superplasticiser is sold in liquid form. The data sheet supplied by the manufacturer stipulates that the quantity of dry extract for this superplasticiser is equal to 31%±1.5%, Several other hydraulic composition formulations were made from this superplasticiser.

### Example 2

### Control Batch Formulations

The purpose of the tests of example 2 was firstly to define a range of values for the proportion of superplasticiser in the hydraulic composition, but also to define a range of values for the calcium salt type setting accelerator and for the Water/Cement ratio.

The produced hydraulic compositions use different cements and fillers and different granulates.

The cements used are from the Lafarge Le Teil cement works in the case of the cement of type OEM I 52.5 R, from the Lafarge Le Havre cement works in the case of the cement of type CEM I 52.5 N, and from the Lafarge Kujawy cement works in Poland in the case of the cement of type CEM I 42.5 R.

The technical characteristics of each of these cements are summarised in table 3 below:

TABLE 3
Technical characteristics of the cements used

| | | Cement 1 | Cement 2 | Cement 3 |
|---|---|---|---|---|
| | | CEM I | CEM I | CEM I |
| | | 52.5 N CE | 52.5 R CE | 42.5 R |
| | | CP2 NF | CP2 NF | Kujawy |
| Cement works: | | Le Havre | Le Teil | Poland |
| Mineralogical | Alite mono | 63.10 | 62.40 | 59.30 |
| composition | Belite | 15.10 | 17.20 | 14.80 |
| (% by mass) | Ferrite | 9.00 | 7.50 | 10.40 |
| | Cubic | 6.60 | 4.30 | 3.10 |
| | aluminate | | | |
| | Ortho | 0.80 | 0.10 | 2.20 |
| | aluminate | | | |
| | Lime CaO | 0.40 | 0.50 | 0.30 |
| | Portlandite | 0.40 | 0.00 | 2.00 |
| | Ca(OH)2 | | | |
| | Periclase | 0.50 | 0.00 | 0.20 |
| | Quartz | 0.00 | 0.20 | 0.20 |
| | Calcite | 0.90 | 3.20 | 4.20 |
| Additives (% by | Gypsum | 1.90 | 1.10 | 0.30 |
| mass) | Semi-hydrate | 1.10 | 0.80 | 3.00 |
| | Anhydrite | 0.20 | 2.60 | 0.00 |
| Free CaO (% by mass) | | 0.85 | 0.52 | 2.14 |
| Soluble alkalines (% | Soluble K2O | 0.32 | 0.14 | 0.44 |
| by mass) | Soluble Na2O | 0.08 | 0.11 | 0.08 |
| Chemical | SiO2 | 20.14 | 20.42 | 19.17 |
| composition | Al2O3 | 5.19 | 4.40 | 4.82 |
| of the clinker | Fe2O3 | 2.78 | 2.42 | 3.17 |
| (% by mass) | CaO | 65.06 | 65.50 | 63.39 |
| | MgO | 1.21 | 0.92 | 1.24 |
| | K2O | 0.36 | 0.15 | 0.57 |
| | Na2O | 0.16 | 0.17 | 0.23 |
| | SO3 | 3.01 | 3.55 | 3.11 |
| | TiO2 | 0.23 | 0.20 | 0.30 |
| | Mn2O3 | 0.09 | 0.05 | 0.08 |
| | P2O5 | 0.20 | 0.07 | 0.12 |
| | Cr2O3 | Value < | Value < | 0.01 |
| | | detection | detection | |
| | | limit | limit | |
| | ZrO2 | 0.02 | 0.02 | 0.01 |
| | SrO | 0.04 | 0.16 | 0.02 |
| | PAF | 1.27 | 1.93 | 3.33 |
| | Total | 99.76 | 99.97 | 99.57 |
| BLAINE surface specific area - | | 3,570 | 4,000 | 3,480 |
| Physical (cm2/g) | | | | |
| Granulo-laser curve | D10 μm | 2.26 | 2.22 | 3.20 |
| cement model | D50 μm | 17.34 | 12.18 | 15.79 |
| (% by mass) | D90 μm | 57.37 | 33.75 | 44.17 |
| | D(4.3) μm | 24.49 | 15.41 | 20.18 |

The limestone fillers, when used, are from the Lafarge Saint Beat quarry, or alternatively are sold by the company Saint-Hilaire under the Filafluid® brand.

The granulates used in the hydraulic compositions, for their part, are from the Lafarge La Patte, La Petite Craz or Yssingeaux quarries.

The granulates used in the compositions according to the invention include sand(s) and chip(s) defined according to standard NF EN 12620-A1 of June 2008.

Each granulate is characterised by two figures: the first corresponds to the “d” as defined in standard NF P 18-545 of September 2011 and the second corresponds to “D” as defined in standard NF P 18-545 of September 2011.

The setting accelerator used is sold by the company Sika® under the trade name Set 02.

The air-entraining agent used is sold by the company BASF® under the trade name MasterAir 104 or by the company Chryso® under the trade name Chryso®Air G100.

Several control batch formulations (T1 to T5) were produced from all or part of these various components using a protocol similar to the one used above for the selection of the superplasticiser.

Since the proportion of air initially contained in the hydraulic composition is not known in advance, the quantity of components of the hydraulic composition was initially determined for a theoretical air proportion equal to 2%.

A measurement of the proportion of air using an aerometer is made at T=60 min., and then the quantities of components of the hydraulic composition were readjusted by calculation according to the real value for the proportion of air which was measured.

The control batch formulations are shown in table 4 below:

TABLE 4
Control batch formulations

| | | Control batches | | | | |
|---|---|---|---|---|---|---|
| | | T1 | T2 | T3 | T4 | T5 |
| Temperature: | | 20° C. | 10° C. | 10° C. | 20° C. | 20° C. |
| Cement | Le Teil CEM I | 448.7 | 352.4 | 389.1 | 382.6 | 400.4 |
| | 52.5 R | | | | | |
| Filler | Saint Béat | 21.6 | 6.9 | 7.7 | | |
| Sand1 | 0/4 La Patte | 743.2 | | | | |
| Sand2 | 0/4 R Petite | | 825.8 | 791.2 | 887.8 | 804.7 |
| | Craz | | | | | |
| Chip1 | 4/6 La Patte | 181.3 | | | | |
| Chip2 | 6/10 La Patte | 182.0 | | | | |
| Chip3 | 10/20 La Patte | 707.2 | | | | |
| Chip4 | Yssingeaux | | | | | |
| | 4/6 | | | | | |
| Chip5 | Yssingeaux | | 214.2 | 205.2 | 230.3 | 208.8 |
| | 6/10 | | | | | |
| Chip6 | Yssingeaux | | 823.7 | 789.1 | 885.5 | 802.6 |
| | 10/14 | | | | | |
| Fluidifier | Optima 100 | 1.20 | 4.03 | 4.17 | 4.16 | 3.65 |
| Setting | Set 02 | 10.58 | 35.67 | 28.13 | 5.43 | 28.39 |
| accelerator | | | | | | |
| Air-entraining | MasterAir 104 | 1.93 | 0.09 | 0.10 | 0.09 | 0.10 |
| agent | | | | | | |

| | | | | | |
|---|---|---|---|---|---|
| Weff | 188.4 | 144.5 | 147.9 | 136.1 | 152.2 |
| W/C | 0.420 | 0.410 | 0.380 | 0.356 | 0.380 |
| Superplasticiser | 0.07% | 0.31% | 0.29% | 0.31% | 0.25% |
| Setting accelerator | 0.84% | 3.37% | 2.43% | 0.50% | 2.43% |

Effective water W_{eff} is the water required to hydrate a hydraulic binder, and the fluidity of a hydraulic composition in the fresh state.

The effective water and its calculation method are discussed in standard EN 206-1/CN of December 2012, page 17, paragraph 3.1.30.

From this table 4, it could be observed that:
the hydraulic composition according to control batch formulation T1 used a proportion of superplasticiser by dry weight compared to the cement which was equal to 0.07%, while the proportion of setting accelerator by dry weight compared to the cement was equal to 0.84% and the W/C ratio was equal to 0.42,
the hydraulic composition according to control formulation T2 used a proportion of setting accelerator by dry weight compared to the cement equal to 3.37%, while the proportion of superplasticiser by dry weight compared to the cement was equal to 0.31% and the W/C ratio was equal to 0.41,
the hydraulic composition according to control formulation T3 used a proportion of setting accelerator by dry weight compared to the cement which was equal to 2.43%, while the proportion of superplasticiser by dry weight compared to the cement was equal to 0.29% and the W/C ratio was equal to 0.38,
the hydraulic composition according to control formulation T4 used a W/C ratio of 0.356, while the proportion of superplasticiser by dry weight compared to the cement was equal to 0.31% and the proportion of setting accelerator by dry weight compared to the cement was equal to 0.50%, and
the hydraulic composition according to control formulation T5 used a proportion of setting accelerator by dry weight compared to the cement which was equal to 2.43%, while the proportion of superplasticiser by dry weight compared to the cement was equal to 0.25% and the W/C ratio was equal to 0.38.

Table 5 below shows the results of the slump tests obtained for control batch formulations T1 to T5 of table 4:

TABLE 5
Results for control batches 1 to 5

| | | Control batches | | | | |
|---|---|---|---|---|---|---|
| | | T1 | T2 | T3 | T4 | T5 |
| Slump | after 5 min. (cm) | | 5.3 | 7.3 | 3.6 | 5.7 |
| (cm) | after 30 min. | 3 | 5.9 | 5.3 | 2.7 | 5.2 |
| | after 60 min. | 2.8 | 5.05 | 6.4 | | 4.8 |
| | after 90 min. | | 4.2 | 6.9 | | 4 |
| | after 120 min. | | | 6.8 | | |

| | | | |
|---|---|---|---|
| Average compression | 15.9 | 23.8 | 35.6 |
| resistance after 24 hours, | | | |
| MPa | | | |

The compression resistance values were obtained according to the test method described in standard NF EN 12390-3 of April 2012.

Table 5 showed that for the hydraulic composition according to control batch formulation T1 for which the proportion of superplasticiser compared to the cement was less than the lower limit of the claimed range, and for which the proportion of setting accelerator and the W/C ratio were within the claimed ranges, was not sufficiently fluid and was different from a consistency of the S1 or S2 type sought.

Similarly, the hydraulic composition according to control batch formulation T2 for which the proportion of setting accelerator by dry weight compared to the cement was higher than the upper limit of the claimed range, while the proportion of superplasticiser and the W/C ratio were within the claimed ranges, had workability which was too short, and compression resistance which was too low, making it different from the sought performance.

Similarly, the hydraulic composition according to control batch formulation T3 for which the proportion of setting accelerator by dry weight compared to the cement was higher than the upper limit of the claimed range, while the proportion of superplasticiser and the W/C ratio were within the claimed ranges, was over-fluidified and was different from a sought consistency of type S1 or S2.

Similarly, the hydraulic composition according to control batch formulation T4 for which the W/C ratio was less than lower limit of the claimed range, while the proportion of superplasticiser by dry weight compared to the cement and the proportion of setting accelerator by dry weight compared to the cement were within the claimed ranges, had poor rheology maintenance, which made this hydraulic composition difficult to handle.

Similarly, the hydraulic composition according to control batch formulation T5 for which the proportion of setting accelerator by dry weight compared to the cement was higher than the upper limit of the claimed range, while the proportion of superplasticiser and the W/C ratio were within the claimed ranges, had poor rheology maintenance after 90 minutes.

### Example 3

### Batch Formulations according to the Invention

Several batch formulations of hydraulic compositions according to the invention (F1 to F18) were produced at a temperature of 20° C. from all or part of the various components presented above, using a procedure similar to that which had been used above to select the superplasticiser.

These batch formulations according to the invention are shown in tables 6A and 6B below:

TABLE 6A
Hydraulic composition formulations according to the invention

| | | Batch formulations | | | | | | | | |
|---|---|---|---|---|---|---|---|---|---|---|
| | | F1 | F2 | F3 | F4 | F5 | F6 | F7 | F8 | F9 |
| Cement 1 | Le Teil | 442.7 | 441.8 | 414.1 | 406.7 | 342.3 | 346.0 | 342.9 | 352.9 | 350.3 |
| | CEM I 52.5 | | | | | | | | | |
| | R | | | | | | | | | |
| Filler 1 | Saint Béat | 21.3 | 21.3 | | 34.5 | 18.0 | 18.2 | 6.8 | 7.0 | 6.9 |
| Filler 2 | Filafluid | | | 35.1 | | | | | | |
| Sand1 | 0/4 La | 876.3 | 928.0 | | | | | | | |
| | Patte | | | | | | | | | |
| Sand2 | Yssingeaux | | | 230.0 | | | | | | |
| | 0/4 | | | | | | | | | |
| Sable3 | 0/4 R | | | 542.8 | 740.3 | 802.2 | 810.9 | 803.6 | 827.1 | 821.0 |
| | Petite Craz | | | | | | | | | |
| Chip1 | 4/6 La | 154.6 | 145.2 | | | | | | | |
| | Patte | | | | | | | | | |
| Chip2 | 6/10 La | 155.2 | 145.7 | | | | | | | |
| | Patte | | | | | | | | | |
| Chip3 | 10/20 La | 603.1 | 566.4 | | | | | | | |
| | Patte | | | | | | | | | |
| Chip4 | Yssingeaux | | | 98.1 | | | | | | |
| | 4/6 | | | | | | | | | |
| Chip5 | Yssingeaux | | | 97.8 | 192.1 | 208.1 | 210.4 | 208.5 | 214.6 | 213.0 |
| | 6/10 | | | | | | | | | |
| Chip6 | Yssingeaux | | | 751.9 | 738.4 | 800.2 | 808.8 | 801.5 | 825.0 | 818.9 |
| | 10/14 | | | | | | | | | |
| Fluidifier1 | Optima 100 | 2.85 | 3.00 | 3.15 | 2.94 | 3.03 | 3.07 | 3.68 | 3.79 | 3.38 |
| Setting | Set 02 | 18.42 | 18.38 | 19.11 | 16.27 | 13.29 | 7.23 | 4.96 | 5.10 | 20.26 |
| accelerator | | | | | | | | | | |
| Air-entraining | MasterAir | 1.90 | 4.43 | 0.98 | 0.96 | 0.70 | 0.44 | 0.42 | 0.09 | 0.09 |
| agent 1 | 104 | | | | | | | | | |
| Weff | | 185.9 | 185.5 | 173.9 | 170.8 | 143.8 | 145.3 | 140.6 | 144.7 | 143.6 |
| W/C | | 0.420 | 0.420 | 0.420 | 0.420 | 0.420 | 0.420 | 0.410 | 0.410 | 0.410 |
| % | | 0.18% | 0.19% | 0.20% | 0.19% | 0.24% | 0.24% | 0.30% | 0.30% | 0.26% |
| Superplasticiser | | | | | | | | | | |
| % Setting | | 1.48% | 1.48% | 1.47% | 1.28% | 1.28% | 0.69% | 0.50% | 0.50% | 1.96% |
| accelerator | | | | | | | | | | |

TABLE 6B
Hydraulic composition formulations according to the invention

| | | Batch formulations | | | | | | | | |
|---|---|---|---|---|---|---|---|---|---|---|
| | | F10 | F11 | F12 | F13 | F14 | F15 | F16 | F17 | F18 |
| Cement | Le Teil | 341.4 | 352.0 | 356.1 | 391.2 | 357.2 | | | 399.6 | |
| 1 | CEM I | | | | | | | | | |
| | 52.5 R | | | | | | | | | |
| Cement | Le Havre | | | | | | 353.0 | 364.2 | | |
| 2 | CEM I | | | | | | | | | |
| | 52.5 N | | | | | | | | | |
| Cement | Kujawy | | | | | | | | | 412.2 |
| 3 | CEM I | | | | | | | | | |
| | 42.5 R | | | | | | | | | |
| Filler 1 | Saint | 6.7 | | | | | | | | |
| | Béat | | | | | | | | | |
| Sable3 | 0/4 R | 800.1 | 816.7 | 826.2 | 786.1 | 840.4 | 822.9 | 814.2 | 803.0 | 827.3 |
| | Petite | | | | | | | | | |
| | Craz | | | | | | | | | |
| Chip3 | 10/20 La | | | | | | | | 814.0 | 838.7 |
| | Patte | | | | | | | | | |
| Chip5 | Yssing- | 207.6 | 211.9 | 214.3 | 203.9 | 218.0 | 213.5 | 211.2 | | |
| | eaux | | | | | | | | | |
| | 6/10 | | | | | | | | | |
| Chip6 | Yssing- | 798.1 | 814.6 | 824.1 | 784.1 | 838.2 | 820.8 | 812.1 | | |
| | eaux | | | | | | | | | |
| | 10/14 | | | | | | | | | |
| Gravil- | 4/10 La | | | | | | | | 212.9 | 219.3 |
| lon7 | Patte | | | | | | | | | |
| Fluid- | Optima | 3.66 | 3.83 | 4.37 | 4.11 | 3.88 | 2.97 | 3.58 | 3.92 | 3.76 |
| ifier1 | 100 | | | | | | | | | |
| Setting | Set 02 | 4.94 | 4.99 | 2.52 | 19.41 | 3.55 | 15.02 | 20.66 | 17.00 | 17.54 |
| accel- | | | | | | | | | | |
| erator | | | | | | | | | | |
| Air- | Master- | | 0.09 | 0.13 | 0.09 | | | | 0.19 | 0.20 |
| entrain- | Air | | | | | | | | | |
| ing | 104 | | | | | | | | | |
| agent 1 | | | | | | | | | | |
| Air- | Chryso ® | 2.19 | | | | 0.10 | 0.10 | 0.10 | | |
| entrain- | Air | | | | | | | | | |
| ing | G100 | | | | | | | | | |
| agent 2 | | | | | | | | | | |
| Weff | | 140.0 | 144.3 | 146.0 | 148.6 | 136.8 | 144.7 | 138.4 | 151.8 | 156.6 |
| W/C | | 0.410 | 0.410 | 0.410 | 0.380 | 0.383 | 0.410 | 0.380 | 0.380 | 0.380 |
| Super- | | 0.30% | 0.31% | 0.35% | 0.29% | 0.31% | 0.24% | 0.27% | 0.28% | 0.26% |
| plastic- | | | | | | | | | | |
| iser | | | | | | | | | | |
| Setting | | 0.50% | 0.50% | 0.25% | 1.71% | 0.35% | 1.47% | 1.96% | 1.47% | 1.50% |
| accel- | | | | | | | | | | |
| erator | | | | | | | | | | |

In all these formulations the proportion of superplasticiser and the proportion of setting accelerator by dry weight compared to the cement, and the W/C ratio, are all within the claimed ranges.

All these formulations include a minimum of 4% of entrapped air and are therefore compliant with standard NF EN 206-1 of December 2012.

Tables 7A and 7B below show the results of the slump and mechanical resistance tests obtained for the batch formulations according to the invention F1 to F18 of tables 6A and 6B.

TABLE 7A
Results for batch formulations F1 to F8 according to the invention

| | | Batch formulations | | | | | | | | |
|---|---|---|---|---|---|---|---|---|---|---|
| | | F1 | F2 | F3 | F4 | F5 | F6 | F7 | F8 | F9 |
| Slump | after 5 min. | | | 6.8 | 7.2 | 7 | 7.7 | 8 | 6.8 | 7 |
| (cm) | after 30 min. | 4.2 | 4.35 | 5.2 | 7 | 7.3 | 6 | 7.9 | 4.9 | 5.3 |
| | after 60 min. | 4.1 | 4.3 | 5.1 | 6.8 | 7 | 6 | 7.6 | 4.9 | 5.6 |
| | after 90 min. | 4.25 | 4.55 | 4.7 | 6 | 6.3 | 5.6 | 7.4 | 4.8 | 5.2 |
| | after 120 | | 4.6 | 4 | 5.2 | 5 | 5.2 | 7.2 | 4.6 | 4.5 |
| | min. | | | | | | | | | |
| Average | after 18 | 32 | 34.3 | | | | | | | |
| compression | hours | | | | | | | | | |
| resistance | after 24 | | 37.3 | 27.9 | 27.1 | 25.5 | 26.1 | 25.2 | 29 | 22.5 |
| (MPa) | hours | | | | | | | | | |
| | after 7 days | | | | | | | 46.8 | 55.4 | |

TABLE 7B
Results for batch formulations F9 to F17 according to the invention

| | | Batch formulations | | | | | | | | |
|---|---|---|---|---|---|---|---|---|---|---|
| | | F10 | F11 | F12 | F13 | F14 | F15 | F16 | F17 | F18 |
| Slump | after 5 min. | 6.1 | | 6.2 | 6.5 | 5.3 | 6.3 | 7 | 5.7 | |
| (cm) | after 30 min. | | | 5.6 | 6 | 4.7 | 5.3 | 6.2 | 5 | 5.7 |
| | after 60 min. | 8 | 6.1 | 5 | 7 | 4.7 | 5.5 | 6.5 | 5 | 5 |
| | after 90 min. | 7 | 6 | 4.9 | 5.6 | 4.2 | 5 | 7.2 | 5.5 | 4.9 |
| | after 120 min. | 7 | 5.6 | 4.6 | 3.5 | 3.8 | 3 | 2.4 | 4.8 | |
| Average | after 7 hours | | | | | | | | 9.8 | 1.4 |
| compression | after 12 hours | | | | | | | | 20 | |
| resistance | after 16 hours | | | | 33 | | | | 27.2 | |
| (MPa) | after 18 hours | | | | 38.8 | 22.5 | | 20 | | |
| | after 24 hours | 27.3 | 25.5 | 34.5 | 42.6 | 29.5 | 22.6 | 26.5 | 39.1 | 28.6 |
| | after 7 days | | | | | 57 | | | | |
| | after 28 days | | | | | 69.5 | | | | 64.6 |

Tables 7A and 7B show that all formulations F1 to F18 have a compression resistance of over 20 MPa after 24 hours at 20° C. Formulations F1, F2 and F13 have a compression resistance of over 30 MPa after 18 hours at 20° C. and even after 16 hours in the case of formulation F13.

Formulation F17 has a compression resistance of 20 MPa after 12 hours at 20° C.

In addition, these formulations give the hydraulic composition a consistency of type S1, S2 or S3 and a workability of between 10° C. and 30° C. allowing its use on site.

1-9. (canceled)

10- A hydraulic composition for the construction of pavements comprising:
a hydraulic binder comprising a cement,
0.18% to 0.35% of a superplasticiser, the percentage being expressed by dry weight compared to the cement, and said superplasticiser comprising a branched polymer including at least one pendant chain, with a terminal function of the phosphonate or phosphate type, and
0.25% to 2% of a setting accelerator, the percentage being expressed by dry
weight compared to the cement, said setting accelerator comprising a calcium salt, said hydraulic composition having a Water/Cement ratio higher than 0.38 and strictly less than 0.45.

11- The hydraulic composition according to claim 10, wherein the number of pendant chains is less than or equal to three.

12- The hydraulic composition according to claim 10, wherein the calcium salt comprises a calcium nitrite, a calcium nitrate or their blends.

13- The hydraulic composition according to claim 10, wherein the cement comprises a Portland cement of the CEM I type according to Cement standard NF EN 197-1.

14- The hydraulic composition according to claim 13, wherein the Portland cement of CEM I type is in resistance category 42.5 N, 42.5 R, 52.5 N or 52.5 R according to Cement standard NF EN 197-1.

15- The hydraulic composition according to claim 10, wherein the cement includes at least one mineral addition.

16- The hydraulic composition according to claim 10, comprising 0.001% to 0.1% of an air-entraining agent, the percentage being expressed by dry weight relative to the cement.

17- The hydraulic composition according to claim 10, comprising 0.001% to 0.06% of an air-entraining agent, the percentage being expressed by dry weight relative to the cement.

18- The hydraulic composition according to claim 16, wherein the air-entraining agent comprises a sulphonic fatty acid, a carboxylic fatty acid, or their blends.

19- A method for construction of pavements comprising utilizing a hydraulic composition according to claim 10, wherein the hydraulic composition is of ready-mixed type, and has a S1, S2 or S3 consistency according to Cement standard NF EN 197-1.

20- The method for construction of pavements according to claim 19, wherein the construction of pavements is repair.
